(19) United States
(12) Patent Application Publication
(10) Pub. No.: US 2017/0087640 A1
(43) Pub. Date: Mar. 30, 2017

(54) PHOTOLUMINESCENT GOLD NANOPARTICLES AND MANUFACTURING METHOD THEREOF

(71) Applicant: Yeu-Kuang HWU, New Taipei City (TW)

(72) Inventors: Yeu-Kuang HWU, New Taipei City (TW); Sheng-Feng LAI, Keelung City (TW); Edwin Bin-Leong ONG, Singapore (SG)

(21) Appl. No.: 15/085,449

(22) Filed: Mar. 30, 2016

(30) Foreign Application Priority Data
Sep. 30, 2015 (TW) 104132229

(51) Int. Cl. B22F 9/24; C22B 3/00

(52) U.S. Cl. CPC B22F 9/24; C22B 11/04; B82Y 30/00

(57) ABSTRACT

Photoluminescent gold nanoparticles and the manufacturing method thereof are disclosed. The method for manufacturing photoluminescent gold nanoparticles includes the steps of: preparing a solution containing chloroauric acid and alkanethiolate, wherein the alkanethiolate-to-Au molar ratio is at least 1; and irradiating the solution with ionizing radiation to form gold nanoparticles, wherein the surfaces of the gold nanoparticles are coated with the alkanethiolate to form thiolate-coated gold nanoparticles with gold cores.

### CROSS REFERENCE TO RELATED APPLICATIONS

This Non-provisional application claims priority under 35 U.S.C. §119(a) on Patent Application No(s). 104132229 filed in Taiwan, Republic of China on Sep. 30, 2015, the entire contents of which are hereby incorporated by reference.

### BACKGROUND OF THE INVENTION

Field of Invention

The invention relates to gold nanoparticles and, in particular, to photoluminescent gold nanoparticles.

Related Art

Photoluminescent gold nanoparticles have received considerable attention recently in various fields due to their unique optical property. Compared with other molecular fluorescent dyes, in addition to better light stability and greater Stokes shift, gold nanoparticles themselves are biocompatible safe material, and it is clinically confirmed that gold is not toxic to organisms. On the contrary, because the material of semiconductor quantum dots which similarly have high quantum efficiency is mostly heavy metal, for example cadmium (Cd), they are toxic and not easy to be metabolized and discharged from human body. Accordingly, the biological application of semiconductor quantum dots is limited.

Various methods are used to synthesize photoluminescent gold nanoparticles, such as direct reduction process, template method, ligand exchange method, or etching method. However, these methods often make clusters not uniform in size due to the instability of the nucleation process. Accordingly, it needs methods for screening particle size and separating (for example molecular sieve, centrifugation, extraction, gel filtration chromatography, or recrystallization) to obtain gold nanoclusters with high quantum yield. As a result, the complex and time-consuming purification processes reduce the possibility of industrial mass production.

### SUMMARY OF THE INVENTION

An aspect of the disclosure is to provide photoluminescent gold nanoparticles and a manufacturing method thereof. The uniform sized photoluminescent gold nanoparticles are directly synthesized by ionizing radiation, and the photoluminescent gold nanoparticles can be modulated to have high quantum yield by varying the surface modifier. The photoluminescent gold nanoparticles made by the manufacturing method according to the disclosure do not need various complex processes for separation and purification subsequently due to the size uniformity. Therefore, industrialized production for such material is more possible.

A method for manufacturing photoluminescent gold nanoparticles includes the steps of: preparing a solution containing chloroauric acid and alkanethiolate, wherein the alkanethiolate-to-Au molar ratio is at least 1; and irradiating the solution with ionizing radiation to form gold nanoparticles, wherein the surfaces of the gold nanoparticles are coated with the alkanethiolate to form thiolate-coated gold nanoparticles with gold cores.

In one embodiment, the alkanethiolate-to-Au molar ratio is 1, 2, 3 or 4.

In one embodiment, the alkanethiolate has a straight-chain alkyl group of 8-16 carbon atoms.

In one embodiment, the alkanethiolate is selected from the group consisting of 8-mercaptooctanoic acid, 9-mercaptononanoic acid, 10-mercaptodecanoic acid, 11-mercaptoundecanoic acid, 12-mercaptododecanoic acid, 13-mercaptotridecanoic acid, 14-mercaptotetradecanoic acid, 15-mercaptopentadecanoic acid, and 16-mercaptohexadecanoic acid.

In one embodiment, the diameter of the gold core within the thiolate-coated gold nanoparticle is less than 3 nm.

In one embodiment, the diameter of the gold core within the thiolate-coated gold nanoparticle is 1.3±0.28 nm.

In one embodiment, the ionizing radiation is X-ray radiation, a neutron beam, an electron beam, or an ion beam.

In one embodiment, the dose rate of the ionizing radiation is greater than 3 mJ/cm² sec.

In one embodiment, the solution is free of a reductant, a surfactant, and a radical scavenger.

Photoluminescent gold nanoparticles are also provided. The photoluminescent gold nanoparticles are manufactured by the method of any one of previous claims.

As mentioned above, as to the photoluminescent gold nanoparticles and the manufacturing method thereof according to the disclosure, the photoluminescent gold nanoparticles of uniform size distribution are directly synthesized through reducing the gold ions in the solution by ionizing radiation. Moreover, the photoluminescent gold nanoparticles can be modulated to have high quantum yield by varying the surface modifier.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a flow diagram of the method for manufacturing the photoluminescent gold nanoparticles according to a preferred embodiment;

FIG. 2 is a schematic diagram of the photoluminescent gold nanoparticles manufactured according to a preferred embodiment;

FIGS. 3A to 3E are UV-visible absorption spectra of the photoluminescent gold nanoparticles which are manufactured in the presence of different n-alkanethiolates having different carbon chain lengths with different R-values in the experimental example 2;

FIGS. 4A to 4C are schematic diagrams showing the particle size distribution of gold core of the photoluminescent gold nanoparticles which are manufactured in the presence of different n-alkanethiolates having different carbon chain lengths as the alkanethiolate surface modifier with the R-value equal to 3 in the experimental example 2;

FIG. 4D is a schematic diagram showing the entire particle sizes of the photoluminescent gold nanoparticles which are manufactured in the presence of different n-alkanethiolates with the R-value equal to 3, wherein the different n-alkanethiolates have different carbon chain lengths, and the entire particle size is characterized by small-angle X-ray scattering in the experimental example 2;

FIG. 5 is a schematic diagram showing the results of analyzing the carbon chain length of the n-alkanethiolates and the particle size of gold core of the photoluminescent gold nanoparticles in the experimental example 2;

FIGS. 6A to 6B are schematic diagrams showing the results of analyzing the carbon chain length (carbon number) of different n-alkanethiolates and the photoluminescence intensity of the photoluminescent gold nanoparticles in the experimental example 3;

FIG. 7 is a schematic diagram showing the results of analyzing the carbon chain length (carbon number) of different n-alkanethiolates and the quantum yield of the photoluminescent gold nanoparticles in the experimental example 4;

FIG. 8 is a schematic diagram showing the cell immunofluorescence staining results using the photoluminescent gold nanoparticles as biological fluorescence labels in the experimental example 5, wherein the photoluminescent gold nanoparticles are manufactured by using 16-mercaptohexadecanoic acid (16-MHDA) as the alkanethiolate surface modifier (the R-value is 3); and

FIG. 9 is a schematic diagram showing the results of the photoluminescence intensity of the photoluminescent gold nanoparticles after different time periods in the experimental example 6, wherein the photoluminescent gold nanoparticles are manufactured by using 16-mercaptohexadecanoic acid (16-MHDA) as the alkanethiolate surface modifier (the R-value is 3).

### DETAILED DESCRIPTION OF THE INVENTION

The embodiments of the invention will be apparent from the following detailed description, which proceeds with reference to the accompanying drawings, wherein the same references relate to the same elements.

The gold nanoparticles or the photoluminescent gold nanoparticles mentioned in the below embodiments are also known as colloidal gold or gold colloid, and they all indicate the system consisting of gold nanoparticles dispersed in a liquid solution. In the following embodiments, the photoluminescent gold nanoparticles are preferably defined as those gold nanoparticles whose quantum yields are larger than 0.001.

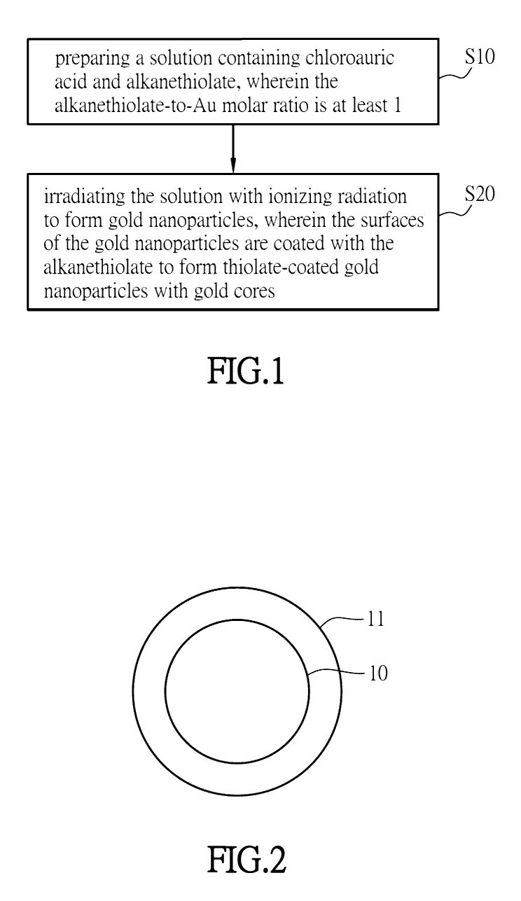

Referring to FIG. 1, it is a flow diagram of the method for manufacturing the photoluminescent gold nanoparticles according to a preferred embodiment. In this embodiment, the method for manufacturing the photoluminescent gold nanoparticles includes the following steps.

Step S10: prepare a solution containing chloroauric acid and n-alkanethiolate. The alkanethiolate-to-Au molar ratio is at least 1. Chloroauric acid is tetrachloroauric acid trihydrate (HAuCl₄.3H₂O), it is dissociated into a hydrogen ion and a chloroauric ion (AuCl₄⁻) after dissolved in water.

Step S20: irradiate the solution prepared in step S10 by ionizing radiation to make chloroauric ions become gold nanoparticles in the solution. The surfaces of the gold nanoparticles are coated with the n-alkanethiolate to form thiolate-coated gold nanoparticles with gold cores. The detailed mechanism is shown as the following equation (1) to equation (4).

HAuCl₄→H⁺+AuCl₄⁻ (1)

H₂O→H.+OH. (2)

4OH.→2H₂O+O₂ (3)

AuCl₄⁻+3H.→Au+3H⁺+4Cl⁻ (4)

The equation (1) indicates that tetrachloroauric acid trihydrate is dissociated into a hydrogen ion and a chloroauric ion (AuCl₄⁻) in water. After the solution is irradiated by ionizing radiation, water molecules are split into hydrogen radicals and hydroxyl radicals (as shown in the equation (2)). Water molecules and oxygen molecules are formed by hydroxyl radicals (as shown in the equation (3)). Chloroauric ions (AuCl₄⁻) reacts with hydrogen radicals to produce gold atoms, hydrogen ions, and chloride ions (as shown in the equation (4)). The gold atoms are further agglomerated into nanoparticles.

Because the irradiation of ionizing radiation is used in the embodiment, the manufacturing process can be simplified under one-pot reaction conditions. Hydrogen radicals obtained by splitting water molecules are used to reduce chloroauric ions to gold nanoparticles. Accordingly, no other reductants are required. Moreover, reactants and products are simple, so there is no need of surfactant, and no byproduct is produced. Furthermore, water molecules and oxygen are formed after the reaction of hydroxyl radicals. The reactants, such as hydrogen radicals or hydrated electrons, are generated quickly and abundantly by irradiation of ionizing radiation, so that no radical scavenger (e.g. 2-propanol) is needed adding into the solution in comparison with other methods which use chemical synthesis.

In addition, to improve reaction results, sodium hydroxide can be added into the solution before performing the reaction to adjust the solution to alkaline or neutral pH so as to avoid pH decrease of the solution caused by accumulation of hydrogen ions in the reaction (referring to the above-mentioned equation (1) to equation (4). Moreover, hydroxyl ions (OH⁻) from sodium hydroxide may serve as ligands for gold ions instead of chloride ions. The reaction is shown as the equation (5) and equation (6).

AuCl₄⁻+4H⁻→Au(OH)₄⁻+4Cl⁻ (5)

Au(OH)₄⁻+3H.→Au+3H₂O+OH⁻ (6)

Referring to FIG. 2, it is a schematic diagram of thiolate-coated gold nanoparticles with gold cores formed according to a preferred embodiment. After the gold nanoparticles are formed in step S20, the surfaces of the gold nanoparticles will be coated with the n-alkanethiolate added into the solution in the step S10 to form a core shell structure as shown in FIG. 2 that the core 10 is the gold nanoparticle and the shell 11 is n-alkanethiolate. As mentioned above, in this embodiment, the alkanethiolate-to-Au molar ratio is at least 1. Preferably, the alkanethiolate-to-Au molar ratio may be 1, 2, 3, or 4. The experiments found that the particle size of gold nanoparticle of the core 10 within the formed core-shell structure is stably kept less than 3 nm, preferably less than 2 nm, if the alkanethiolate-to-Au molar ratio in the solution is not less than 1. Preferably, the diameter of gold core is 1.3±0.28 nm. In one embodiment, the entire particle size (including the shell 11) of the above mentioned thiolate-coated gold nanoparticle with the gold core is about 2 to 5 nm. The ionizing radiation for irradiation may be synchrotron X-ray radiation, a neutron beam, an electron beam, or an ion beam. In the below experiments, the reaction volume is 10 mL, and the reaction time for irradiation of ionizing radiation is 60 seconds. The actual reaction time for irradiation of ionizing radiation depends on the reaction volume. The dose rate of the ionizing radiation may be greater than about 10¹² photons/mm² sec or may be greater than about 3 mJ/cm² sec. Expressed in units of Gy/s, the dose rate of the ionizing radiation used in the below experiments is about 4.7×10⁵ Gy/s. In the embodiment, irradiating the solution with ionizing radiation adopts the above mentioned dose and irradiation time, so a large amount of free radicals are instantly generated and can simultaneously react with all chloroauric ions and/or gold hydroxide ions (Au(OH)₄). Moreover, there is sufficient n-alkanethiolate under the condition that the alkanethiolate-to-Au molar ratio is not less than 1, so the surfaces of the gold nanoparticles can be coated with the n-alkanethiolate timely. Thus, the problems of oversized particles and sedimentation which result from the overgrowth and agglomeration of particles caused by long time irradiation and insufficient n-alkanethiolate coated on the gold nanoparticle surfaces can be avoided.

Moreover, the experiments found that when the alkanethiolate-to-Au molar ratio less than 1, the carbon number of the n-alkanethiolate in the solution in step S10 is negatively correlated with the particle size of the gold nanoparticles manufactured by the method according to the embodiment. It is also found that when the alkanethiolate-to-Au molar ratio is more than or equal to 1, the carbon number of the n-alkanethiolate in the solution in step S10 is positively correlated with the quantum yield of the photoluminescent gold nanoparticles. More specifically, when the alkanethiolate-to-Au molar ratio is less than 1 and the carbon number of the n-alkanethiolate is greater (i.e. the straight-chain alkyl group is longer), the particle size of the gold core of the obtained gold nanoparticles is smaller. Moreover, when the alkanethiolate-to-Au molar ratio is greater than or equal to 1 and the carbon number of the n-alkanethiolate is greater, the quantum yield of the obtained photoluminescent gold nanoparticles is higher. However, if the alkanethiolate-to-Au molar ratio is greater than or equal to 1, the particle size is not significantly changed and the photoluminescent gold nanoparticles have significant photoluminescence (quantum yield>0.001). In a preferred embodiment, the carbon number of the straight-chain alkyl group of the n-alkanethiolate is preferably 8 to 16. When the alkanethiolate-to-Au molar ratio is less than 1, the sizes of gold nanoparticles varies with the carbon number of the n-alkanethiolates, and such gold nanoparticles do not reveal significant photoluminescence properties (quantum yield<0.001). Such phenomenon in size variation may be explained by noting that the n-alkanethiolates with shorter straight-chain alkyl group (less carbon number) have lower reactive binding probability to the surfaces of gold nanoparticles since the shorter carbon chain n-alkanethiolates have the greater activation barrier for the sulfur-hydrogen bond (S—H bond) dissociation. When the alkanethiolate-to-Au molar ratio is greater than or equal to 1, the cause of enhanced photoluminescence may be a ligand effect affecting the local quantum states and the corresponding optical transitions, or self-absorption effect that longer chain coatings cause less absorption, allowing the photoluminescence to reach vacuum. Moreover, the below experimental examples 2, 3 and 4 show that the particle size of the gold core is no longer affected by the carbon number under the high R-value (when the R-value is not less than 1). Therefore, the photoluminescent gold nanoparticles which have uniform sized gold cores can be synthesized according to the manufacturing method of the embodiment. The effect of the carbon chain length (carbon number) of the straight-chain alkyl group of the n-alkanethiolates on the quantum yield is discussed in the following experimental examples.

In this preferred embodiment, in step S10, the n-alkanethiolate in the solution is preferably 8-mercaptooctanoic acid (8-MOA), 9-mercaptononanoic acid, 10-mercaptodecanoic acid, 11-mercaptoundecanoic acid (11-MUA), 12-mercaptododecanoic acid (12-MDA), 13-mercaptotridecanoic acid, 14-mercaptotetradecanoic acid, 15-mercaptopentadecanoic acid, or 16-mercaptohexadecanoic acid (16-MHDA). The experiments found that the quantum yield of the photoluminescent gold nanoparticles which are manufactured by using 16-mercaptohexadecanoic acid (16-MHDA) as the surface modifier is up to 28%. It can be expected that the quantum yield would be higher when using longer straight-chain alkyl group.

The “solution” mentioned in the embodiment indicates water, deionized water, or alcohol (including methanol, ethanol, propanol, butanol, and the like), but it is not limited thereto. The person who skilled in the art may also use other suitable solutions, such as carbon tetrachloride, chloroform or the like, as long as such solutions are capable of generating any free radicals or chemicals as reductants by irradiation of ionizing radiation.

The photoluminescent gold nanoparticles manufactured in the embodiment may be concentrated by a centrifuge to form a concentrated colloid which may be further dispersed to form another colloid. The particle size of the gold nanoparticles in the colloid which is concentrated or re-dispersed is still substantially equal to that in the original colloid.

In addition, another preferred embodiment is also provided. The embodiment is photoluminescent gold nanoparticles which are manufactured by the manufacturing method shown in the above mentioned embodiments. The parameters of their manufacturing process are the same as the above preferred embodiments, so they are not repeated here.

The features of the method for manufacturing the photoluminescent gold nanoparticles and the obtained photoluminescent gold nanoparticles according to the above embodiments will become more fully understood by the person who skilled in the art from the following experimental examples which further illustrate the parameters of the above method for manufacturing the photoluminescent gold nanoparticles and the physical and chemical properties of the obtained photoluminescent gold nanoparticles.

### Experimental Example 1: Preparing the Photoluminescent Gold Nanoparticles

Chloroauric acid (HAuCl₄.3H₂O), n-alkanethiolates and sodium hydroxide (NaOH) used in this experimental example and the following experimental examples were all purchased from Sigma-Aldrich.

0.5 mL of 0.25 mM HAuCl₄.3H₂O were adjusted to pH 11 with 0.1 M NaOH. Afterward, the n-alkanethiolates dissolved in anhydrous ethanol and deionized water were added to reach a 10 mL volume. The alkanethiolate-to-Au molar ratio (R) was adjusted depend on different needs. The solution was placed in polypropylene conical tubes and irradiated while stirring for 60 seconds by using the BL01A beamline from the storage ring of the NSRRC (Taiwan National Synchrotron Radiation Research Center), running at a constant electron current of 300 mA. The above mentioned beamline was an unmonochromatized white X-ray beamline, and the slit system was used to make the above beamline to form a 10×10 mm² transverse beam. The beamline photon energy ranged from 8-15 keV and was centred at ˜12 keV delivering a dose rate of ˜4.7×10⁵ Gy/s. After the irradiation, the solution was dialyzed with deionized water to remove ethanol and unbound n-alkanethiolates. Accordingly, the photoluminescent gold nanoparticles can be obtained.

The particle size and its distribution of the photoluminescent gold nanoparticles were characterized by small-angle X-ray scattering (SAXS) using the BL23A beamline from the storage ring of NSRRC. All of the SAXS data were obtained using an area detector covering a q range from 0.01 to 0.1 Å⁻¹, and the incident angle of the X-ray beamline (0.5 mm diameter) was fixed at 0.2° with an X-ray energy of 10 keV. Afterward, the obtained data were analyzed using the sphere-model fitting and Guinier's law to acquire the particle size and its distribution of the photoluminescent gold nanoparticles. The detailed steps may refer to A. Guinier and G. Fournet, Small angle scattering of X-rays, John Wiley & Sons, New York, 1955, and R. J. Roe, Methods of X-Ray and Neutron Scattering in Polymer Science, Oxford University Press, New York, 2000.

### Experimental Example 2: The Effect of the Alkanethiolate-to-Au Molar Ratio (R) on the Particle Size of the Photoluminescent Gold Nanoparticles

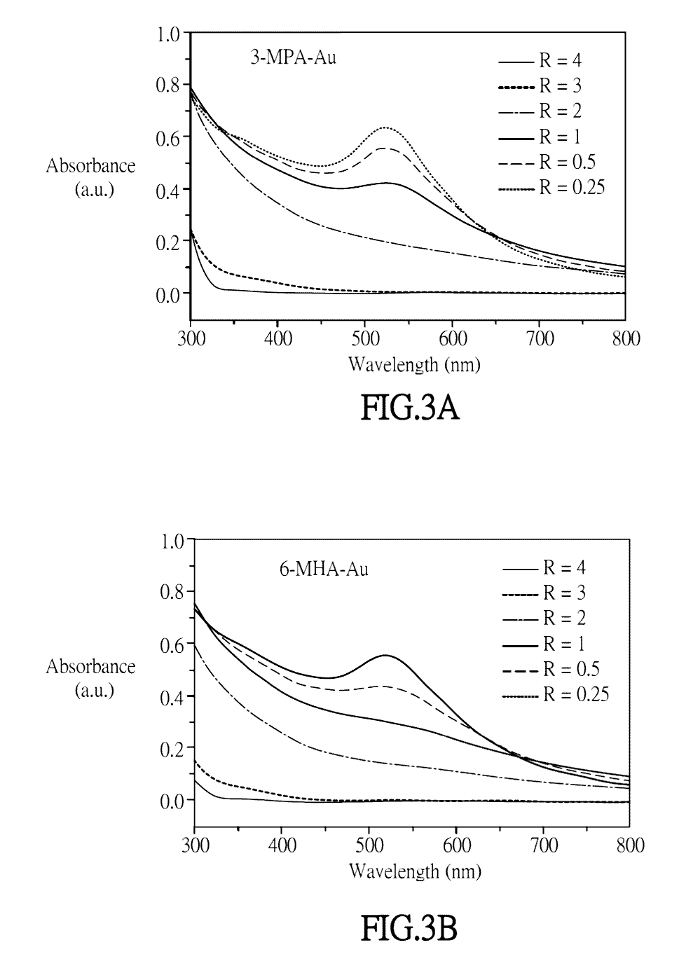

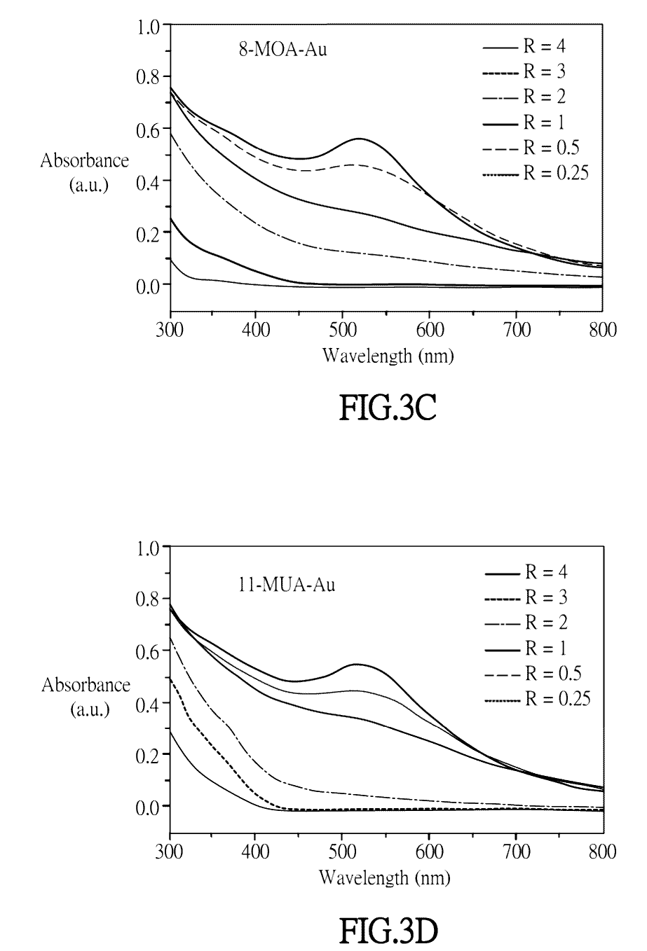

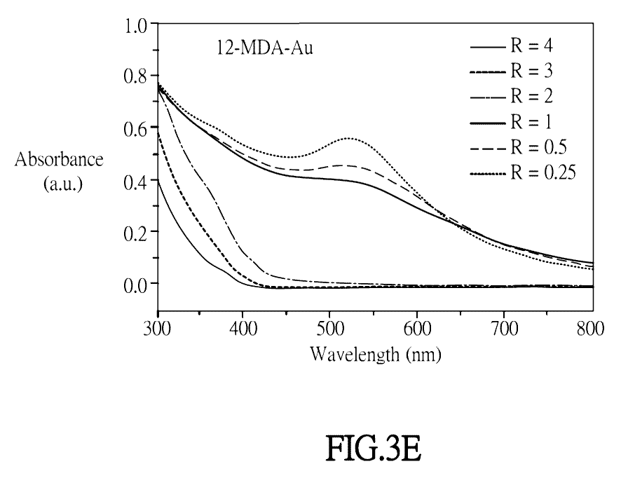

Different photoluminescent gold nanoparticles were prepared according to the steps described in the experimental example 1 by using 8-mercaptooctanoic acid (8-MOA), 11-mercaptoundecanoic acid (11-MUA), 12-Mercaptododecanoic acid (12-MDA), and 16-mercaptohexadecanoic acid (16-MHDA) as the alkanethiolate surface modifier, and the alkanethiolate-to-Au molar ratios (R, namely the ratio of n-alkanethiolate molar concentration to Au molar concentration) were adjusted to 0.25, 0.5, 1, 2, 3 and 4. Moreover, 3-mercaptopropionic acid (3-MPA) and 6-mercaptohexanoic acid (6-MHA) were used as controls. UV-visible spectra were acquired over 200-800 nm using a USB4000 Fiber Optic spectrometer from Ocean Optics (Dunedin, USA). The UV-visible spectra of the photoluminescent gold nanoparticles which are manufactured in the presence of different n-alkanethiolates having different carbon chain lengths with different R-values are shown in FIGS. 3A to 3E. The behaviour of the surface plasmon resonance (SPR) peak (the portion of 500-600 nm wavelength in FIG. 3A to FIG. 3E) of respective photoluminescent gold nanoparticles in FIGS. 3A to 3E shows that the particle size of the photoluminescent gold nanoparticles decreases when the R-value increases. Moreover, the particle size distribution of the photoluminescent gold nanoparticles is stabilized and the surface plasmon resonance peak no longer occurs when the R-value is not less than 1.

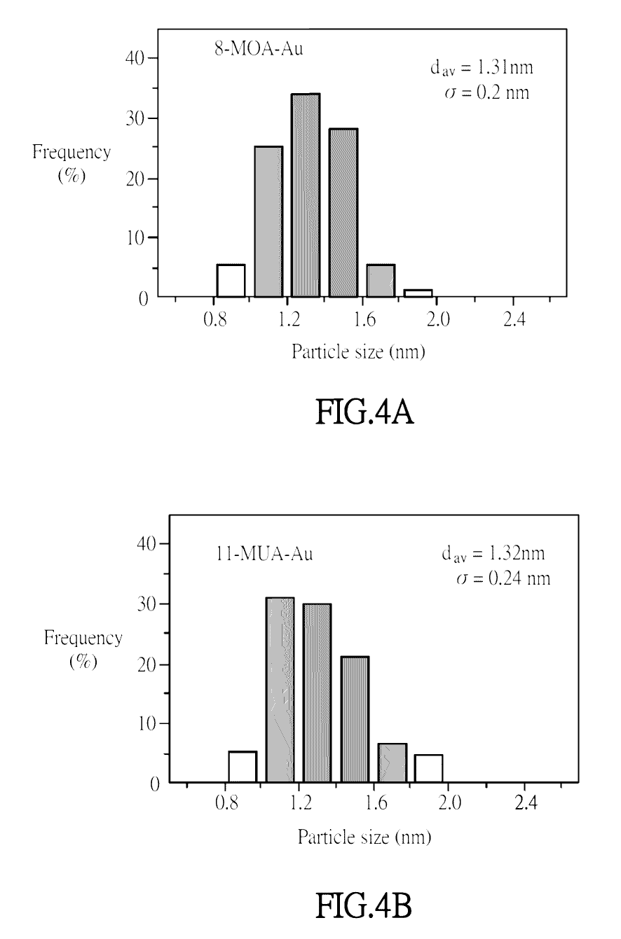

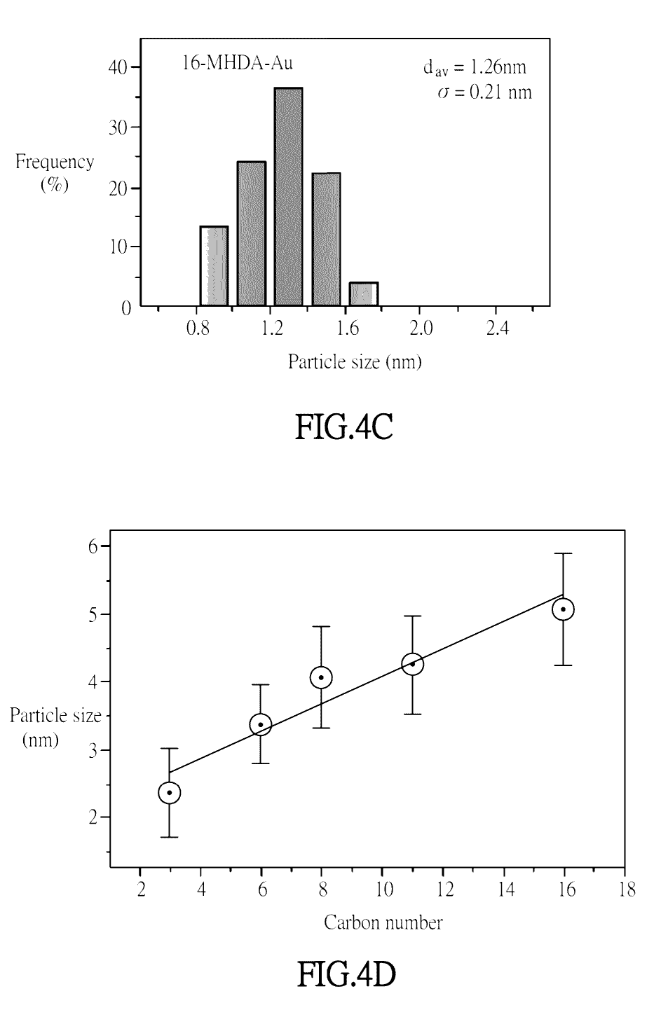

FIGS. 4A to 4C respectively show that the particle size distributions of gold core of the photoluminescent gold nanoparticles which are respectively manufactured in the presence 8-mercaptooctanoic acid (8-MOA), 11-mercaptoundecanoic acid (11-MUA), and 16-mercaptohexadecanoic acid (16-MHDA) as the alkanethiolate surface modifier with the R-value equal to 3. As shown in the figures, when the R-value is equal to 3, the particle sizes of gold core of the photoluminescent gold nanoparticles are all less than 3 nm, preferably less than 2. Moreover, when 8-mercaptooctanoic acid (8-MOA) is used as surface modifier, the average particle size (dₐᵥ) is 1.31 nm and the standard deviation (SD, σ) is 0.2 nm. When 11-mercaptoundecanoic acid (11-MUA) is used as surface modifier, the average particle size (dₐᵥ) is 1.32 nm and the standard deviation (SD, σ) is 0.24 nm. When 16-mercaptohexadecanoic acid (16-MHDA) is used as surface modifier, the average particle size (dₐᵥ) is 1.26 nm and the standard deviation (SD, σ) is 0.21 nm. FIG. 4D shows the entire particle sizes of the photoluminescent gold nanoparticles which are manufactured in the presence of different n-alkanethiolates with the R-value equal to 3, the different n-alkanethiolates have different carbon chain lengths, and the entire particle size is characterized by small-angle X-ray scattering. As shown in the figure, the longer the carbon chain length is, the greater the entire particle size is. The entire particle size is about 2 to 5 nm.

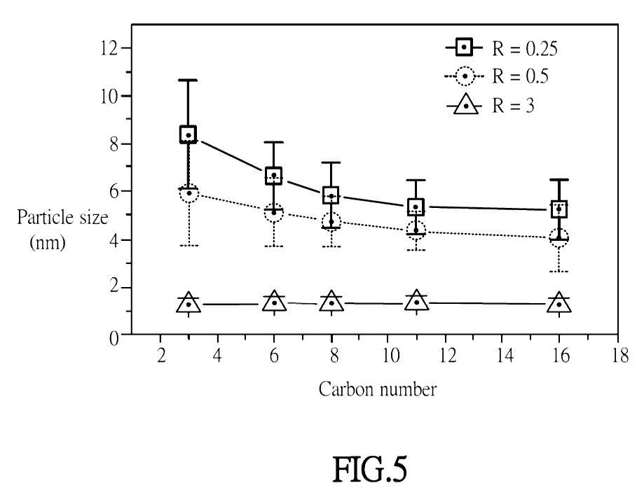

The carbon chain length (i.e. the carbon number of straight-chain alkyl group) of the n-alkanethiolates and the particle size of gold core of the photoluminescent gold nanoparticles are analyzed. The results are shown in FIG. 5. As shown in the figure, when the R-value is 0.25 and 0.5, the carbon chain length of the n-alkanethiolates affects the particle size of gold core of the obtained photoluminescent gold nanoparticles. However, when the R-value is not less than 1 (the R-value equal to 3 is taken for example in FIG. 5), the particle size of gold core of the obtained photoluminescent gold nanoparticles is stably kept less than 2 nm. This is because there are sufficient n-alkanethiolates in the solution to rapidly react with the gold nanoparticles and then the surfaces of the gold nanoparticles are coated with the n-alkanethiolates when the R-value is not less than 1. Thus, the overgrowth and agglomeration of the gold nanoparticles can be avoided so the nanoparticles won't be oversized.

### Experimental Example 3: The Effect of the Carbon Chain Length (Carbon Number) of the n-Alkanethiolates on the Photoluminescence Intensity of the Photoluminescent Gold Nanoparticles

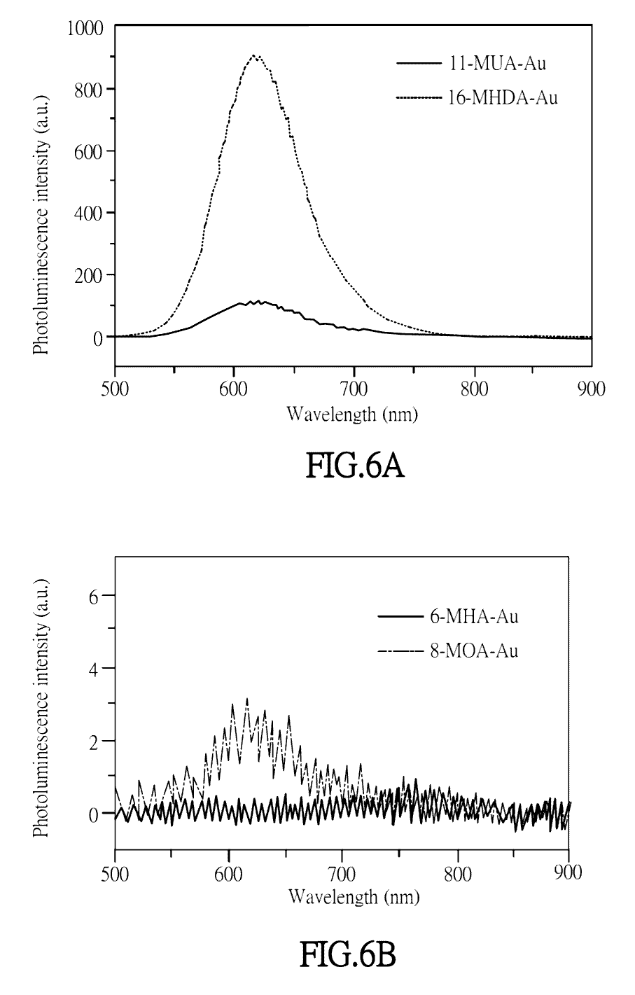

Different photoluminescent gold nanoparticles were prepared according to the steps described in the experimental example 1 by using 8-mercaptooctanoic acid (8-MOA), 11-mercaptoundecanoic acid (11-MUA), and 16-mercaptohexadecanoic acid (16-MHDA) as the alkanethiolate surface modifier, and the alkanethiolate-to-Au molar ratio (R) was adjusted to 3 (the Au molar ratio is 4 μM). Moreover, 6-mercaptohexanoic acid (6-MHA) was used as a control. Photoluminescence spectra and photoluminescence intensity of the photoluminescent gold nanoparticles excited by 240 nm wavelength UV radiation were recorded at room temperature using a Cary Eclipse spectrophotometer (Varian, USA). The results show that an emission peak (not shown in figures) position at 618 nm occurs regardless of the carbon chain length (carbon number) of the n-alkanethiolates when the photoluminescent gold nanoparticles were excited by 240 nm wavelength UV radiation at room temperature. The photoluminescence intensities of emission peak position at 618 nm of the photoluminescent gold nanoparticles manufactured by using the n-alkanethiolates of different carbon chain lengths are shown in FIG. 6A and FIG. 6B. As shown in the figures, for the carbon chain length (carbon number) of the n-alkanethiolates not greater than 8, the photoluminescence can be detected but is quite weak. When the carbon chain length (carbon number) of the n-alkanethiolates is greater than 8, the photoluminescence intensity increases with the carbon chain length (carbon number) of the n-alkanethiolates.

### Experimental Example 4: The Effect of the Carbon Chain Length (Carbon Number) of the n-Alkanethiolates on the Quantum Yield of the Photoluminescent Gold Nanoparticles

This experimental example is similar to the experimental example 3. Different photoluminescent gold nanoparticles were prepared according to the steps described in the experimental example 1 by using 8-mercaptooctanoic acid (8-MOA), 11-mercaptoundecanoic acid (11-MUA), and 16-mercaptohexadecanoic acid (16-MHDA) as the alkanethiolate surface modifier, and the alkanethiolate-to-Au molar ratio (R) was adjusted to 3. Moreover, 3-mercaptopropionic acid (3-MPA) and 6-mercaptohexanoic acid (6-MHA) were used as controls. The photoluminescence intensity and UV-visible absorption spectra were acquired, and then the quantum yield of respective photoluminescent gold nanoparticles is calculated from absorption and photoluminescence results.

General quantum yield is the number of the acquired excited fluorescence quanta after the excitation by the light of specific energy. In this embodiment, the quantum yield is calculated by using a standard phenylalanine (its quantum yield is 2.2% in water) and the following equation (7).

$${Φ}_{i} = \frac{{F}_{i} {f}_{s}}{{F}_{s} {f}_{i}} {Φ}_{s} \qquad ( 7 )$$

In the equation (7), Φᵢ is the quantum yield of the sample to be tested in water; Φₛ is the quantum yield of standard phenylalanine in water; Fᵢ and Fₛ are the integrated emission areas of the standard and sample spectra respectively; fᵢ and fₛ are the absorption factors for the standard and the sample that are calculated by the following equation (8).

f=1-10^{-A} (8)

In the equation (8), f is the absorption factor, and A is the absorbance of the standard and the sample at 240 nm wavelength.

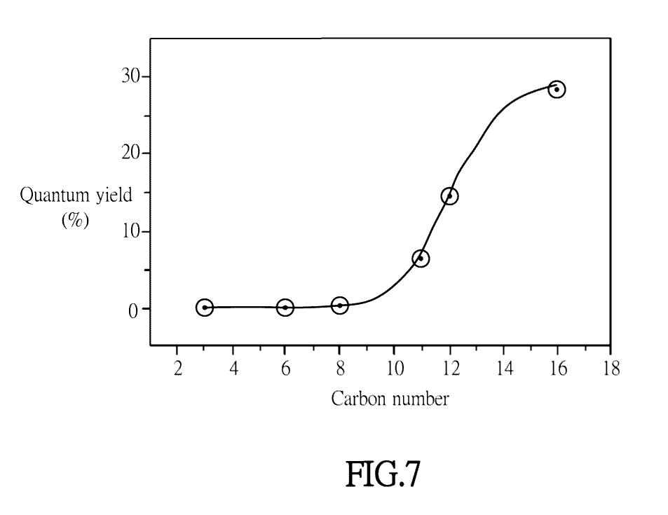

The quantum yields of respective photoluminescent gold nanoparticles are calculated by the above equations as shown in FIG. 7. As shown in the figure, when the carbon chain length (carbon number) of the n-alkanethiolates is greater than 8, it is positively correlated with the quantum yield of the photoluminescent gold nanoparticles. Moreover, when the carbon chain length (carbon number) of the n-alkanethiolates is 16, the quantum yield of the obtained photoluminescent gold nanoparticles may further reach about 28%.

The results of the experimental example 3 and the experimental example 4 show that the longer carbon chain (the carbon number is at least greater than 8) n-alkanethiolates improve not only the photoluminescence intensity but also the photoluminescence efficiency of the obtained photoluminescent gold nanoparticles.

### Experimental Example 5: The Photoluminescent Gold Nanoparticles Serving as Biological Fluorescence Labels

The photoluminescent gold nanoparticles were prepared according to the steps described in the experimental example 1 by using 16-mercaptohexadecanoic acid (16-MHDA) as the alkanethiolate surface modifier, and the alkanethiolate-to-Au molar ratio (R) was adjusted to 3. Without making surface conjugation with other molecules, the photoluminescent gold nanoparticles were directly co-cultured with the HeLa cells. The result of the photoluminescent gold nanoparticles internalized in the cells is observed using a multi-photon excitation fluorescence confocal microscopy.

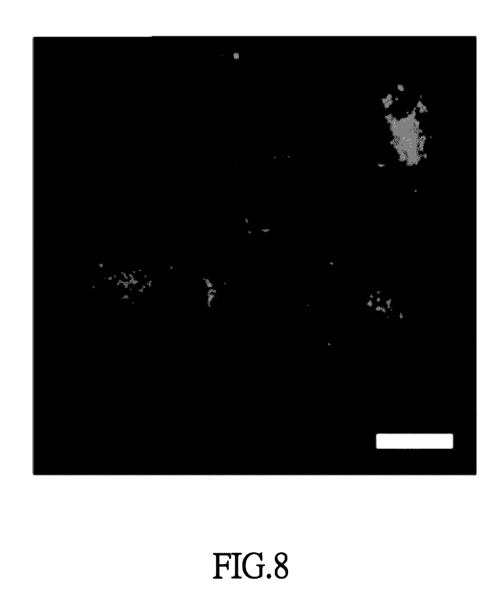

As shown in FIG. 8, the photoluminescent gold nanoparticles can be internalized into the cytoplasm of the HeLa cells, and the multi-photon excitation microscopy image shows that the photoluminescent gold nanoparticles still keep the photoluminescent properties in the cells. Moreover, the carboxylic acid functional groups on the surfaces of the photoluminescent gold nanoparticles preserve the possibility of further conjugation with other functional molecules (e.g. antibodies performing specific labeling) so as to offer a wide range of possible applications. Therefore, the photoluminescent gold nanoparticles manufactured according to this embodiment are suitable for biological fluorescence labels.

### Experimental Example 6: The Long-Term Stability of the Photoluminescent Gold Nanoparticles

The photoluminescent gold nanoparticles were prepared according to the steps described in the experimental example 1 by using 16-mercaptohexadecanoic acid (16-MHDA) as the alkanethiolate surface modifier, and the alkanethiolate-to-Au molar ratio (R) was adjusted to 3. Moreover, the photoluminescent gold nanoparticles were preserved in the light-proof environment at 4° C. to test their photoluminescence intensities after different time periods.

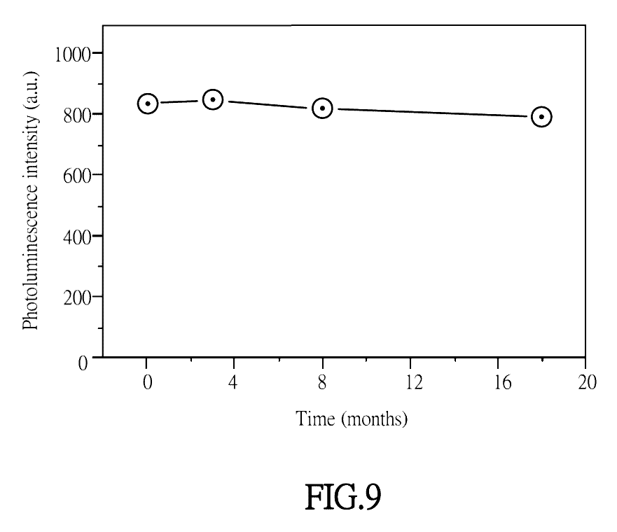

As shown in FIG. 9, the photoluminescence intensity does not significantly decrease after several months (even in 18 months). The results show that the long-term preservation does not affect the photoluminescent properties of the photoluminescent gold nanoparticles manufactured according to this embodiment.

In summary, as to the photoluminescent gold nanoparticles and the manufacturing method thereof according to the disclosure, the uniform sized photoluminescent gold nanoparticles are directly synthesized by ionizing radiation, and the photoluminescent gold nanoparticles can be modulated to have high quantum yield by varying the surface modifier. The photoluminescent gold nanoparticles made by the manufacturing method according to the disclosure do not need various complex processes for separation and purification subsequently due to the size uniformity. Therefore, industrialized production for such material is more possible.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A method for manufacturing photoluminescent gold nanoparticles, comprising:
preparing a solution containing chloroauric acid and alkanethiolate, wherein the alkanethiolate-to-Au molar ratio is at least 1; and
irradiating the solution with ionizing radiation to form gold nanoparticles, wherein the surfaces of the gold nanoparticles are coated with the alkanethiolate to form thiolate-coated gold nanoparticles with gold cores.

2. The method of claim 1, wherein the alkanethiolate-to-Au molar ratio is 1, 2, 3 or 4.

3. The method of claim 1, wherein the alkanethiolate has a straight-chain alkyl group of 8-16 carbon atoms.

4. The method of claim 3, wherein the alkanethiolate is selected from the group consisting of 8-mercaptooctanoic acid, 9-mercaptononanoic acid, 10-mercaptodecanoic acid, 11-mercaptoundecanoic acid, 12-mercaptododecanoic acid, 13-mercaptotridecanoic acid, 14-mercaptotetradecanoic acid, 15-mercaptopentadecanoic acid, and 16-mercaptohexadecanoic acid.

5. The method of claim 1, wherein the diameter of the gold core within the thiolate-coated gold nanoparticle is less than 3 nm.

6. The method of claim 4, wherein the diameter of the gold core within the thiolate-coated gold nanoparticle is 1.3±0.28 nm.

7. The method of claim 1, wherein the ionizing radiation is X-ray radiation, a neutron beam, an electron beam, or an ion beam.

8. The method of claim 7, wherein the dose rate of the ionizing radiation is greater than 3 mJ/cm² sec.

9. The method of claim 1, wherein the solution is free of a reductant, a surfactant, and a radical scavenger.

10. Photoluminescent gold nanoparticles manufactured by the method of claim 1.

11. The photoluminescent gold nanoparticles of claim 10, wherein the alkanethiolate-to-Au molar ratio is 1, 2, 3 or 4.

12. The photoluminescent gold nanoparticles of claim 10, wherein the alkanethiolate has a straight-chain alkyl group of 8-16 carbon atoms.

13. The photoluminescent gold nanoparticles of claim 12, wherein the alkanethiolate is selected from the group consisting of 8-mercaptooctanoic acid, 9-mercaptononanoic acid, 10-mercaptodecanoic acid, 11-mercaptoundecanoic acid, 12-mercaptododecanoic acid, 13-mercaptotridecanoic acid, 14-mercaptotetradecanoic acid, 15-mercaptopentadecanoic acid, and 16-mercaptohexadecanoic acid.

14. The photoluminescent gold nanoparticles of claim 10, wherein the diameter of the gold core within the thiolate-coated gold nanoparticle is less than 3 nm.

15. The photoluminescent gold nanoparticles of claim 14, wherein the diameter of the gold core within the thiolate-coated gold nanoparticle is 1.3±0.28 nm.

16. The photoluminescent gold nanoparticles of claim 10, wherein the ionizing radiation is X-ray radiation, a neutron beam, an electron beam, or an ion beam.

17. The photoluminescent gold nanoparticles of claim 16, wherein the dose rate of the ionizing radiation is greater than 3 mJ/cm² sec.

18. The photoluminescent gold nanoparticles of claim 10, wherein the solution is free of a reductant, a surfactant, and a radical scavenger.
